(19) United States
(12) Patent Application Publication
(10) Pub. No.: US 2017/0152937 A1
(43) Pub. Date: Jun. 1, 2017

(54) Machine Having an Electrical Power System that Includes a Planetary Gear System

(71) Applicant: Caterpillar Inc., Peoria, IL (US)

(72) Inventors: Timothy Schlack, Washington, IL (US); Joseph Tigue, Peoria, IL (US); Jonathan Baumann, Hanna City, IL (US)

(73) Assignee: Caterpillar Inc., Peoria, IL (US)

(21) Appl. No.: 14/953,920

(22) Filed: Nov. 30, 2015

(51) Int. Cl. F16H 57/08; E02F 9/20; E02F 9/22; F16H 1/28; F16H 57/04

(52) U.S. Cl. CPC F16H 57/082; F16H 1/28; F16H 57/043; E02F 9/22; E02F 9/202

(57) ABSTRACT

A drive coupling configured to operate with an electrical power system of a machine is disclosed. The drive coupling includes a planetary gear system including a ring gear configured to receive input from an engine and a sun gear configured to drive a drive shaft of a generator, a plurality of planet gears each arranged on a planet gear shaft, the plurality of planet gears meshing with the sun gear and the ring gear, and a planet carrier includes a first planet carrier deck and a second carrier deck having an open portion therebetween to receive the sun gear and the plurality of planet gears. The drive coupling further includes a bearing arranged in the planet carrier configured to support the drive shaft of the generator.

### TECHNICAL FIELD

The disclosure relates generally to machines having electrical power generation systems that include a planetary gear system, and relates more particularly to electrical power systems having a drive coupling within the electrical power generation system that is configured with a planetary gear system.

### BACKGROUND

A variety of work machines such as, bulldozers, loaders, excavators, motor graders, and other types of construction, work, and earth moving machinery use a combustion engine such as an internal combustion engine and a generator to produce electrical power. Engine-driven generators have been used in electrically powered mobile machines to provide electrical power for propulsion and operation of machine systems.

In such strategies, rather than requiring rapid ramp-up and down of engine output to accommodate changes in power demand, more stable, smooth operation and transition across an engine power output range may be achieved. In other words, by powering some or all of the machine systems with electrical power provided by an on-board engine and generator system, combustion characteristics and overall engine operation can be more predictable and changes less rapid. This avoids wide and rapid swings in engine speed and load associated with changes in power demand on the system. Where engine operation is more predictable, and changes in engine output more gradual, superior control over emissions and other factors such as fuel efficiency has been demonstrated as compared to traditional designs wherein an engine directly powers the machine propulsion system, hydraulics, etc.

However, some generators demand a rotational speed that may be considerably greater than a normal rotational speed of the engine in order to achieve maximum capability and efficiency. In these situations, mechanical components are required to realize the desired speed demand by the generator. Such mechanical components can be costly, require complex manufacturing, are undesirably large, and the like. For example, such mechanical components have constructions that include wall and support structures arranged therein that increase manufacturing complexity and cost such as a center wall.

One such mechanical component is disclosed in U.S. Pat. No. 2,815,974 entitled engine-generator coupling. In this patent, a planetary gearing and an overriding clutch couples the generator to the engine. When the engine and the generator are at the same speed the engine drives the generator through a direct drive.

It would accordingly be beneficial to have a mechanical component to provide a desired rotational speed that is less costly, requires less complex manufacturing, and is more compact.

### SUMMARY

In one aspect, a drive coupling configured to operate with an electrical power system of a machine, the drive coupling includes a planetary gear system including a ring gear configured to receive input from an engine and a sun gear configured to drive a rotor shaft of a generator, a plurality of planet gears each arranged on a planet gear shaft, the plurality of planet gears meshing with the sun gear and the ring gear, a planet carrier including a first planet carrier deck and a second carrier deck having an open portion therebetween to receive the sun gear and the plurality of planet gears, and a bearing arranged in the planet carrier configured to support the rotor shaft of the generator.

In another aspect, a machine includes a frame, a generator arranged on the frame and configured to generate electrical power for the machine, an engine arranged on the frame and configured to rotate the generator, a planetary gear system including a ring gear configured to receive input from the engine and a sun gear configured to drive a rotor shaft of the generator, a plurality of planet gears each arranged on a planet gear shaft, the plurality of planet gears meshing with the sun gear and the ring gear, a planet carrier including a first planet carrier deck and a second carrier deck having an open portion therebetween to receive the sun gear and the plurality of planet gears, and a bearing arranged in the planet carrier configured to support the rotor shaft of the generator.

These and other aspects and features of the disclosure will be more readily understood upon reading the following description when taken in conjunction with the accompanying drawings.

### BRIEF DESCRIPTION OF THE DRAWINGS

FIG. 1 is a side view of a machine having an electrical power system in accordance with aspects of the disclosure.

FIG. 2 is a schematic of a drivetrain, in accordance with aspects of the disclosure.

FIG. 3 is a front side perspective view of the planetary gear system, in accordance with aspects of the disclosure.

FIG. 4 is an exploded view of the planetary gear system of FIG. 3.

FIG. 5 is a partial cross-sectional view of a planetary gear system of FIG. 3.

FIG. 6 is a partial exploded view of the planetary gear system of FIG. 3.

FIG. 7 is a partial exploded view of the planetary gear system of FIG. 3.

### DETAILED DESCRIPTION

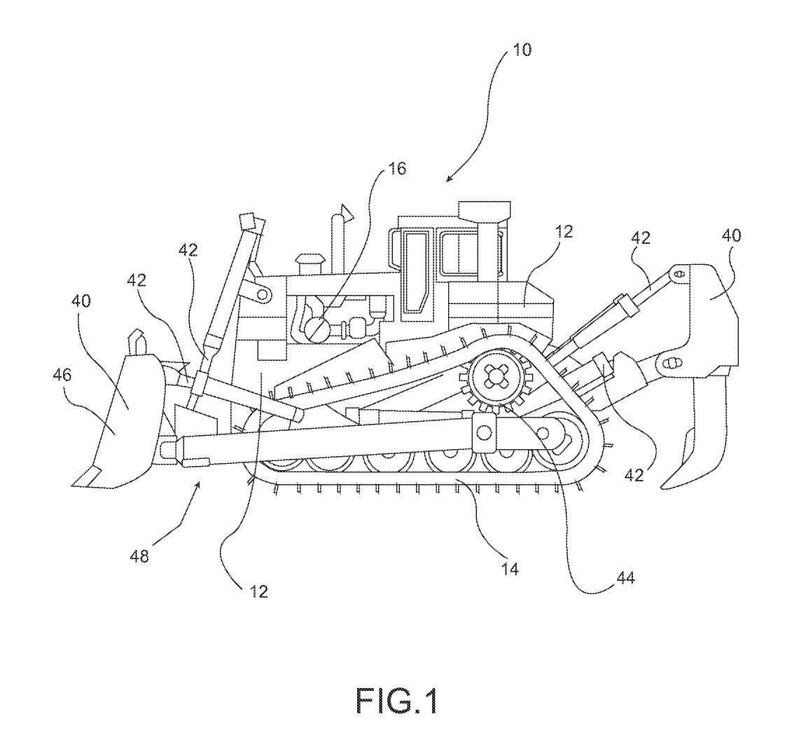

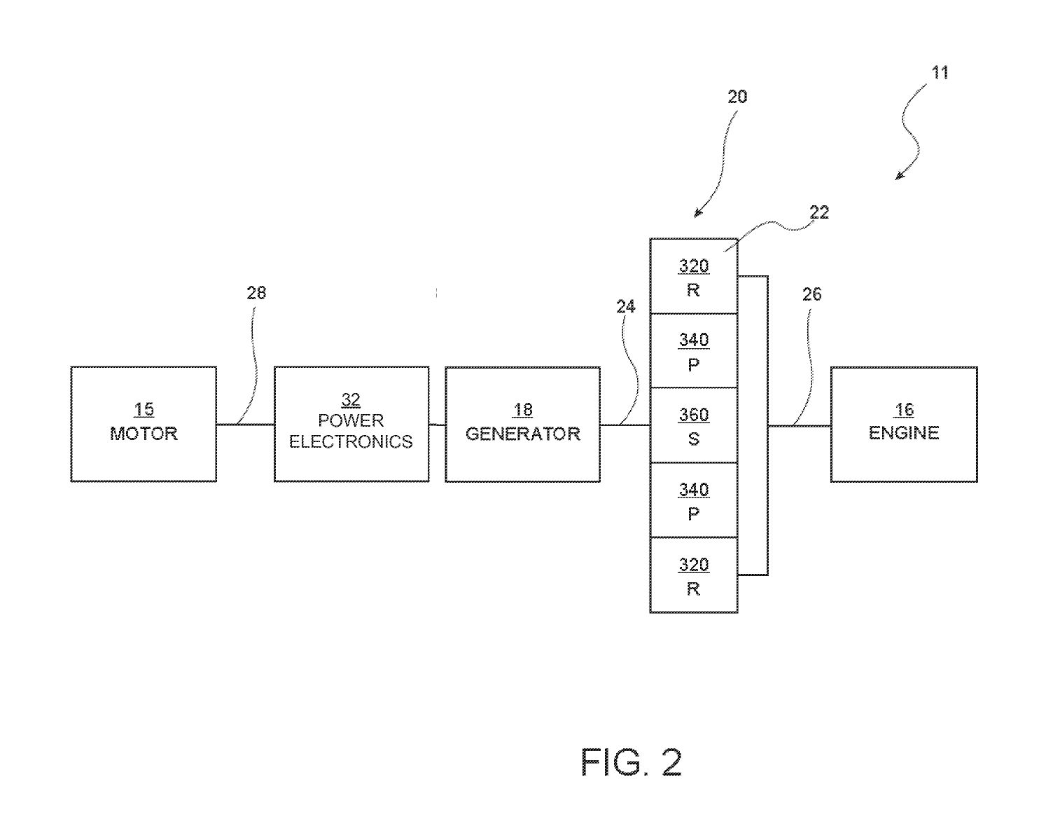

FIG. 1 is a side view of a machine, for example a track type tractor, having an electrical power system in accordance with aspects of the disclosure. The machine 10 may include a set of ground engaging elements such as tracks 14, only one of which is visible in FIG. 1, for propelling the machine 10. The tracks 14 may be moved by operation of a sprocket 44 that may be driven by an electric motor 15 (shown in FIG. 2). Other ground engaging implementations such as a tire and wheel combination are contemplated as well. The machine 10 may include an engine 16. The machine 10 may further include one or more work implements 40 that may be actuated by one or more hydraulic cylinders 42. The hydraulic cylinders 42 may be operated by a hydraulic system (not shown). The various components of the machine may be mounted to a machine frame 12.

The work implements 40 may include a blade 46 as shown at the front of the machine 10 and/or a ripper shown at the back of the machine 10. The blade 46 may be connected for operation to the machine frame 12 by a pair of push arms 48. The operation of the push arms 48 may be controlled by one or more actuators, such as, the hydraulic cylinders 42. The hydraulic cylinders 42 may be extended or retracted to operate the push arms 48. The operation of the hydraulic cylinders 42 may in turn be controlled by the hydraulic system under command of an operator operating the machine 10. Alternatively, the operation of the hydraulic cylinders 42 may in turn be controlled by the hydraulic system under command by an automatic controller operating the machine 10.

FIG. 2 is a schematic of a drivetrain 11, in accordance with at least some aspects of the disclosure. The drivetrain 11 is mounted to the machine frame 12. The drivetrain 11 is a series electric drivetrain which includes the engine 16 that may include an output shaft 26 configured to rotate a generator 18 which is configured to provide electrical power for the machine 10. The machine 10 may also include a drive coupling 20 configured for transmitting torque and appropriate speed correlation between the engine 16 and the generator 18, as further described herein. The electric motor 15 may be further connected to the generator 18 by power lines 28. The machine 10 may also include power electronics 32. The power electronics 32 may include appropriate hardware and/or software for delivering power to the electric motor 15 from the generator 18. The power electronics 32 may further include appropriate hardware and/or software for controlling an operation of the electric motor 15. The electric motor 15 may be configured to accomplish some form of work such as propel the machine 10 by the movement of the ground engaging member (e.g., drive the tracks 14 through the sprocket 44). The electric motor 15, together with the ground engaging member, the drive coupling 20 and the drivetrain 11 encompasses a propulsion system for the machine 10.

The drive coupling 20 may be configured to transmit torque between the engine 16 and the generator 18. To this end, the drive coupling 20 may include or be coupled with a planetary gear system 22 that may rotate a generator rotor shaft 24 via the drive coupling 20, in turn rotating the generator 18 and generating electrical power. In the example shown in FIG. 2, the output shaft 26 and the generator rotor shaft 24 are illustrated in a coaxial configuration. The term “generator,” however, should not be so strictly limited as to exclude alternators and the like.

In the particular aspect shown in FIG. 2, the engine 16 may drive the output shaft 26 that is configured to be connected to and provide input to a ring gear 320. The planetary gear system 22 increases the rotational speed provided by the engine 16 and subsequently outputs the increased rotational speed through a sun gear 360 for driving the generator 18. The planetary gear system 22 is thus a ring gear in/sun gear out configuration.

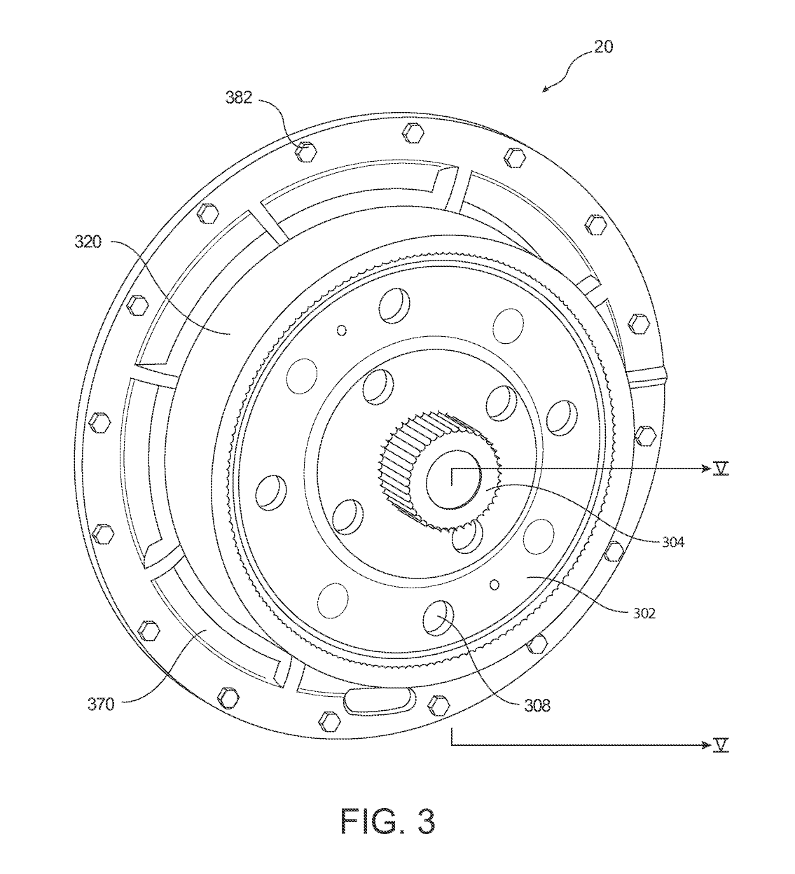

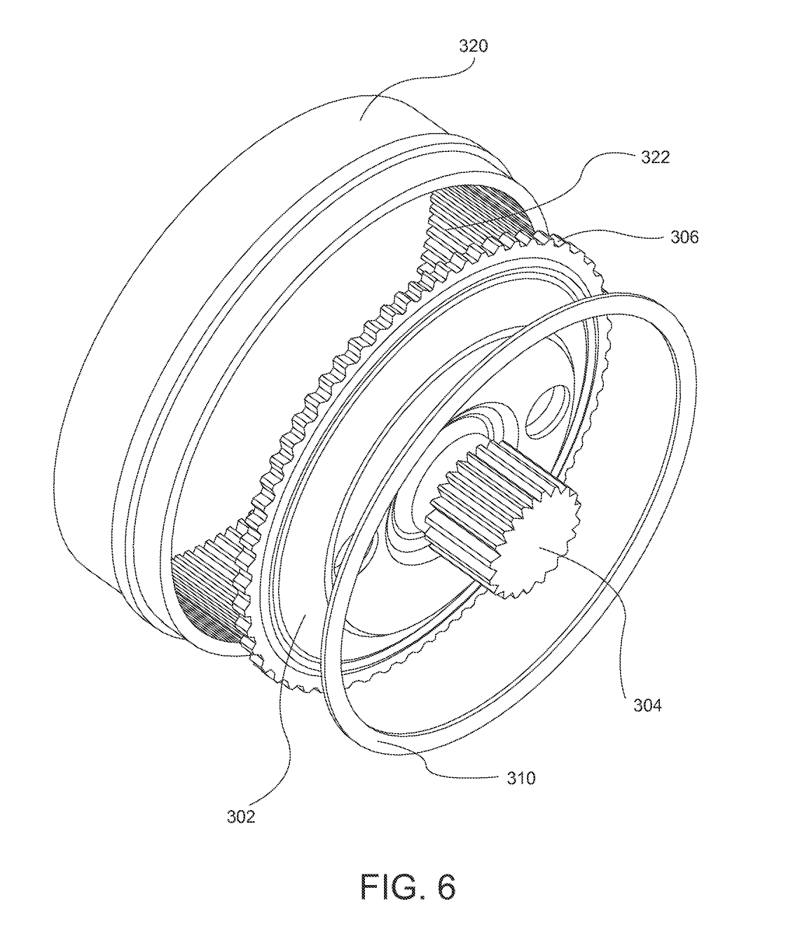

FIGS. 3-7 illustrate the planetary gear system, in accordance with at least some aspects of the disclosure. As shown in FIGS. 3-7, the drive coupling 20 may include an input hub 302. The input hub 302 may connect to an output shaft 26 of the engine 16 (shown in FIG. 2) in any known manner. In the aspect shown in FIGS. 3-7, the input hub 302 may include an input shaft 304. The input shaft 304 may be configured as a splined shaft. The input hub 302 may further include gear teeth 306 (shown in FIG. 6) that may mesh with a set of ring gear teeth 322 of the ring gear 320. The input hub 302 may be held with respect to the ring gear 320 by any known mechanical fastener. In the aspect shown in FIGS. 3-7, the input hub 302 may be fastened to the ring gear 320 with a snap ring 310 that may be arranged in a slot in the ring gear 320.

The input hub 302 may further include one or more apertures 308. The apertures 308 may provide access locations for providing lubricant to the internal portions of the coupling 20. The apertures 308 may function to provide areas of strain relief for any heat treatment of the input hub 302 during manufacturing. Moreover, the apertures 308 may function to reduce the weight of the input hub 302.

The ring gear 320, and in particular the ring gear teeth 322 of the ring gear 320 may mesh with one or more planet gears 340. Each of the planet gears 340 may be mounted on a planet gear shaft 346. Arranged between each of the planet gears 340 and the planet gear shafts 346 may be a bearing 342 to reduce any rotational friction that may be experienced by the planet gears 340 with respect to the planet gear shaft 346. The bearing 342 may be a ball bearing, needle bearing, sleeve bearing, or the like.

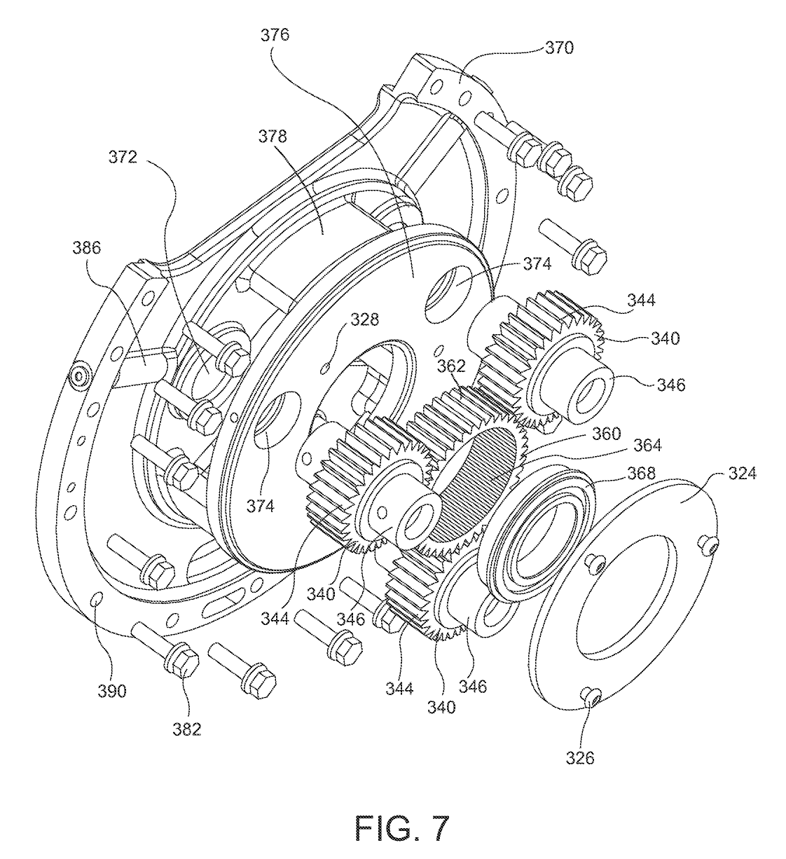

The planet gears 340 are positioned circumferentially around and may mesh with the sun gear 360. In particular, planet gear teeth 344 of the planet gears 340 may mesh with teeth 362 of the sun gear 360. The sun gear 360 may further include a connection mechanism 364 to connect with and transfer torque to the generator 18. In particular, the sun gear 360 may be configured to transfer torque to the generator rotor shaft 24 of the generator 18 (shown in FIG. 2). In the aspect shown in FIG. 7, the sun gear 360 may include internal splines as the connection mechanism 364 to transfer torque to the generator rotor shaft 24 of the generator 18. The generator rotor shaft 24 may have corresponding splines.

As further shown in FIG. 7, the drive coupling 20 may further a planet carrier that includes a first planet gear carrier deck 370. The first planet gear carrier deck 370 may include a first aperture 372 positioned therein to hold a first end of the planet gear shaft 346 and a second aperture 374 may carry an opposing end of the planet gear shaft 346. In this regard, the first planet gear carrier deck 370 may include a second planet gear carrier deck 376 that may be configured with the second aperture 374. The other planet gears 340 may be held in a similar manner. Accordingly, the planet carrier may include the first planet gear carrier deck 370 and the second planet gear carrier deck 376.

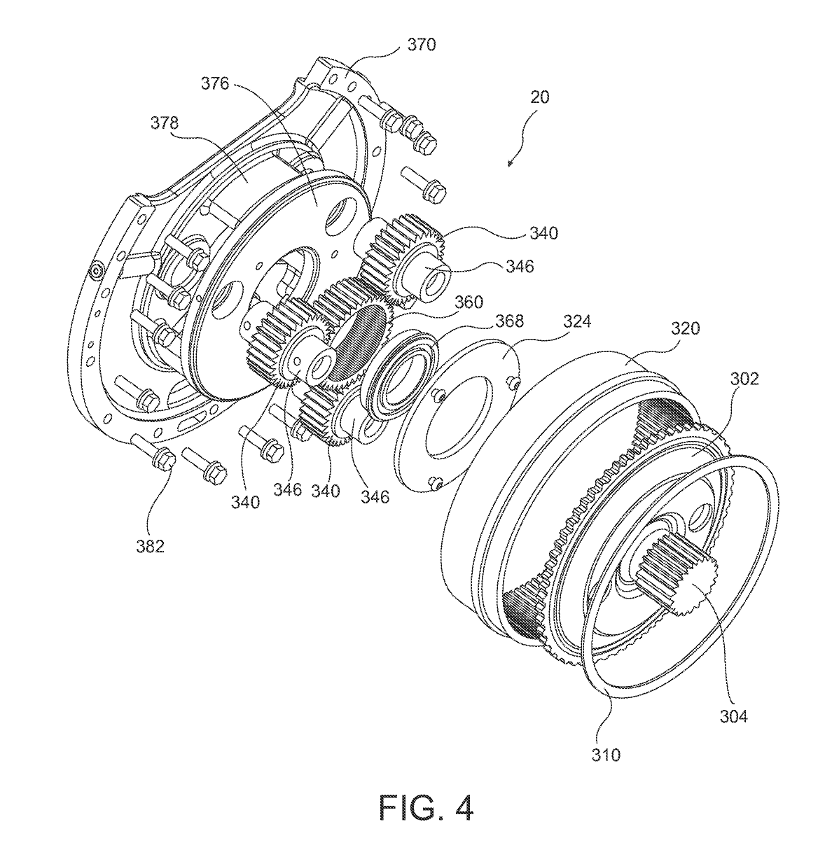

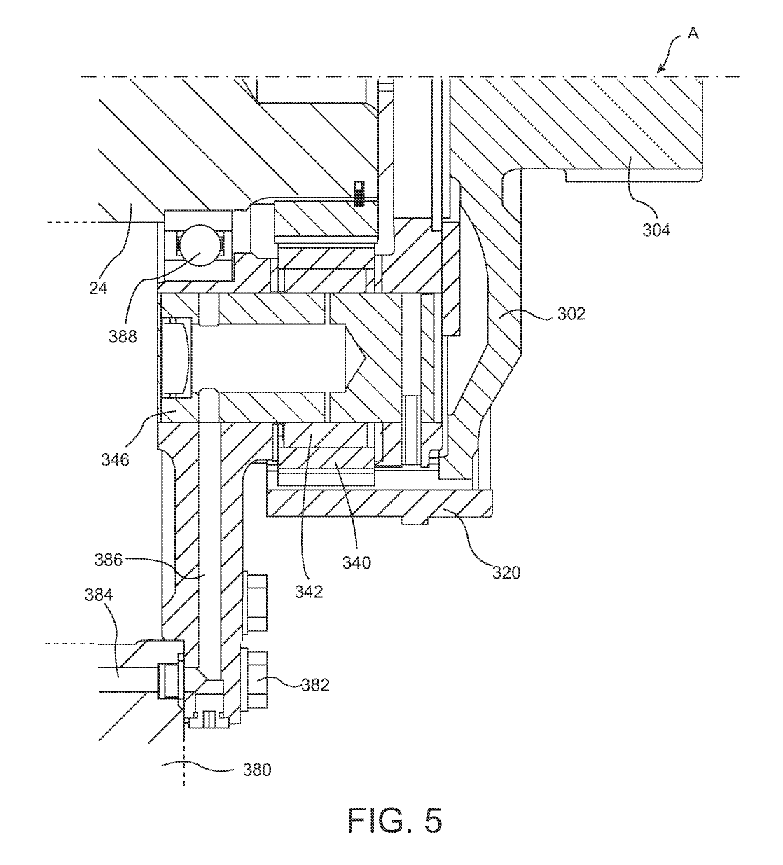

It should be noted that the exploded views of FIG. 4 and FIG. 7 show the sun gear 360 and the planet gears 340 with each of the planet gear shafts 346 separate from the first planet gear carrier deck 370. However, the sun gear 360 and the planet gears 340 with each of planet gear shafts 346 are arranged between the first planet gear carrier deck 370 and the second planet gear carrier deck 376 when operatively arranged as shown in FIG. 5.

The first planet gear carrier deck 370 is spaced apart from and held in a fixed relationship to the second planet gear carrier deck 376 through an attachment configuration 378. The attachment configuration 378 may include a plurality of attachment configurations arranged radially at several locations between the first planet gear carrier deck 370 and the second planet gear carrier deck 376. In a particular aspect, the first planet gear carrier deck 370 is implemented as a fixed carrier. The first planet gear carrier deck 370 in this context may be one where the first planet gear carrier deck 370 does not rotate during operation. In a particular aspect, the first planet gear carrier deck 370 and/or the second planet gear carrier deck 376 may be generally flat, disk shaped portions without any central wall construction between the generator 18 and the planetary gear system 22 implementing a speed up arrangement. In this regard, the first planet gear carrier deck 370 may act as an end cap for the generator 18.

With reference to FIG. 5, the first planet gear carrier deck 370 may mechanically fasten to a housing 380 associated with the generator 18 by a plurality of fasteners. In the aspect shown in FIG. 4, the mechanical fasteners are shown as a plurality of bolts 382, but other types of fasteners are contemplated as well. The plurality of bolts 382 may extend through apertures 390 (shown in FIG. 7) arranged on an outside diameter of the first planet gear carrier deck 370 to connect with the housing 380.

Still referring to FIG. 5, the housing 380 of the generator 18 may also include a conduit 384 that provides lubrication to the first planet gear carrier deck 370. In this regard, the conduit 384 may connect to a conduit 386 arranged within the first planet gear carrier deck 370. Thus, when lubricant is pumped through the conduit 384, the lubricant may continue into the conduit 386 to lubricate various components of the drive coupling 20. The conduit 386 may connect directly with the planet gear shaft 346 which may further include a central bore and one or more cross holes to provide lubricant to the planet gears 340 which may also lubricate the sun gear 360. In the example shown, the first planet gear carrier deck 370 is cast but could be fabricated from machined plate steel and welded. As shown in FIG. 5, the conduits 384, 386 may include one or more seals, positioned between the interface of the housing 380 of the generator 18 and the first planet gear carrier deck 370 to reduce leaking and one or more plugs for gaining access for repairs.

The drive coupling 20 may further include a retainer 368 and a retaining plate 324. The retainer 368 may contact the top of the sun gear 360, portions of the planet gear shaft 346, and the like. The retaining plate 324 may contact the surface of the retainer 368 and maintain the retainer 368 in position within the drive coupling 20. The retaining plate 324 may further include one or more mechanical fasteners 326 that may fasten the retaining plate 324 to the second planet gear carrier deck 376. In one aspect, the mechanical fasteners 326 may be fastened to apertures 328. Other constructions of the retainer 368 and retaining plate 324 are contemplated.

With reference to FIG. 5, the first planet gear carrier deck 370 may include a bearing 388. The bearing 388 may be fit into the first planet gear carrier deck 370. The bearing 388 is positioned about the generator rotor shaft 24 of the generator 18. In this manner the first planet gear carrier deck 370 provides support for both the planet gears 340 and the rotor of the generator 18 through the generator rotor shaft 24.

### INDUSTRIAL APPLICABILITY

The drive coupling 20 may have a simpler construction without the need for a center wall within the drive coupling 20 between the generator 18 and the planetary gear system 22 implementing a speed up arrangement as described herein. In contrast, prior art designs require a more complex construction, such as a construction that includes a center wall between the generator and the planetary speed up arrangement. In this regard, with the first planet gear carrier deck 370 as described above being a fixed carrier, it not only supports the generator rotor shaft 24 of the generator 18 by way of the bearing 388, it also acts as the end cap for the generator 18. This construction is simpler compared to prior art implementations and reduces the number of components needed. Moreover, the first planet gear carrier deck 370 takes the place of a generator end cap and acts not only to complete a closure to the generator 18, but the first planet gear carrier deck 370 also supports the generator rotor shaft 24. Furthermore, because the first planet gear carrier deck 370 is fixed, it further supports the planet gears 340. The drive coupling 20 also assists in alignment between the engine 16 and generator 18, increases rotational speed provided to the generator 18, provides support for the generator rotor shaft 24 as well as housing the planetary gear system 22 arrangement.

The drive coupling 20 has a construction that results in reduced joint requirements and smaller and/or less expensive fasteners. In this regard, with reference to FIG. 7 the mechanical fasteners may include the plurality bolts 382 that may extend through apertures 390 arranged on an outside diameter of the first planet gear carrier deck 370 to connect with the housing 380. Arranging the bolts 382 on the outside diameter of the first planet gear carrier deck 370 reduces the joint requirements and allows for smaller and/or less expensive fasteners.

The drive coupling 20 allows for an in-line geometry from the input hub 302 to the generator rotor shaft 24 of the generator 18 (see dashed line A in FIG. 5) that may result in a more compact overall generator packaging with roughly the same space claim as the torque converters utilized in mechanical drive machines.

The drive coupling 20 allows for a carrier casting construction that may be leveraged to provide lubrication distribution. In this regard, FIG. 5 illustrates the housing 380 that may also include the conduit 384 that provides lubrication to the first planet gear carrier deck 370. Moreover, the conduit 384 may connect to the conduit 386 arranged within the first planet gear carrier deck 370. Thus, when lubricant is pumped through the conduit 384, the lubricant may continue into the conduit 386 to lubricate various components of the drive coupling 20. The conduit 386 may connect directly with the planet gear shaft 346 which may further include a central bore and one or more cross holes to provide lubricant to the planet gears 340 which may also lubricate the sun gear 360. Any one or more of the conduits may be part of a casting. For example, the conduit 386 may be cast with the first planet gear carrier deck 370.

The drive coupling 20 may have particular industrial applicability by providing splines on the ring gear 320 and splines on the sun gear 360 to help manage manufacturing tolerances and provide longer component lives. In this regard, the planetary gear system 22 may be quite constrained because of where the bearings 388 are placed relative to the gears. The component lives are heavily dependent on positional tolerances of features that locate these bearings 388 and common manufacturing capabilities to some extent limit that tolerance. Incorporating the spline connections on the input and output gears adds compliance to the system and allows the parts to work within an envelope to self-locate which to some extent may negate some of the location variability.

We claim:

1. A drive coupling configured to operate with an electrical power system of a machine, the drive coupling comprising:
a planetary gear system including a ring gear configured to receive input from an engine and a sun gear configured to drive a rotor shaft of a generator;
a plurality of planet gears each arranged on a planet gear shaft, the plurality of planet gears meshing with the sun gear and the ring gear;
a planet carrier comprising a first planet carrier deck and a second carrier deck having an open portion therebetween to receive the sun gear and the plurality of planet gears; and
a bearing arranged in the planet carrier configured to support the rotor shaft of the generator.

2. The drive coupling of claim 1 wherein the planet carrier is configured to remain fixed with respect to a housing of the generator and the plant carrier is further configured to enclose an end of the housing of the generator.

3. The drive coupling of claim 1 wherein the planet carrier comprises fasteners arranged on an outside diameter of the planet carrier, the fasteners configured to fasten the planet carrier to a housing of the generator.

4. The drive coupling of claim 1 wherein the planet carrier comprises a lubrication conduit configured to receive a lubrication fluid and direct the lubrication fluid to at least the plurality of planet gears.

5. The drive coupling of claim 1 wherein the open portion comprises an unobstructed clearance area arranged between the first planet carrier deck and the second carrier deck, the unobstructed clearance area configured to receive the sun gear, the plurality of planet gears, and the rotor shaft of the generator.

6. The drive coupling of claim 1 wherein the sun gear comprises splines configured to receive splines of the rotor shaft of the generator.

7. The drive coupling of claim 1 further comprising an input hub comprising hub gear teeth that mesh with ring gear teeth of the ring gear.

8. The drive coupling of claim 7 wherein the input hub comprises a shaft with splines configured to receive torque from the engine.

9. The drive coupling of claim 1 wherein the generator is configured to operate at a first rotational speed that is greater than a second rotational speed of the engine, wherein the planetary gear system is configured to receive the first rotational speed of the engine and generate the second rotational speed for the generator.

10. The drive coupling of claim 1 further comprising an attachment portion connected to an outside edge of the second carrier deck, and the attachment portion further connected to the first planet carrier deck.

11. A machine comprising:
a frame;
a generator arranged on the frame and configured to generate electrical power for the machine;
an engine arranged on the frame and configured to rotate the generator;
a planetary gear system including a ring gear configured to receive input from the engine and a sun gear configured to drive a rotor shaft of the generator;
a plurality of planet gears each arranged on a planet gear shaft, the plurality of planet gears meshing with the sun gear and the ring gear;
a planet carrier comprising a first planet carrier deck and a second carrier deck having an open portion therebetween to receive the sun gear and the plurality of planet gears; and a bearing arranged in the planet carrier configured to support the rotor shaft of the generator.

12. The machine of claim 11 wherein the planet carrier is configured to remain fixed with respect to a housing of the generator and the plant carrier is further configured to enclose an end of the housing of the generator.

13. The machine of claim 11 wherein the planet carrier comprises fasteners arranged on an outside diameter of the planet carrier, the fasteners configured to fasten the planet carrier to a housing of the generator.

14. The machine of claim 11 wherein the planet carrier comprises a lubrication conduit configured to receive a lubrication fluid and direct the lubrication fluid to at least the plurality of planet gears.

15. The machine of claim 11 wherein the open portion comprises an unobstructed clearance area arranged between the first planet carrier deck and the second carrier deck, the unobstructed clearance area configured to receive the sun gear, the plurality of planet gears, and the rotor shaft of the generator.

16. The machine of claim 11 wherein the sun gear comprises splines configured to receive splines of the rotor shaft of the generator.

17. The machine of claim 11 further comprising an input hub comprising hub gear teeth that mesh with ring gear teeth of the ring gear,
wherein the input hub comprises a shaft with splines configured to receive torque from the engine.

18. The machine of claim 11 further comprising a propulsion system for the machine which includes the generator, the engine, the planetary gear system, and electrically powered track type ground engaging elements that are configured to propel the machine.

19. The machine of claim 11 wherein the generator is configured to operate at a first rotational speed that is greater than a second rotational speed of the engine,
wherein the planetary gear system is configured to receive the first rotational speed of the engine and generate the second rotational speed for the generator.

20. The machine of claim 11 further comprising an attachment portion connected to an outside edge of the second carrier deck, and the attachment portion further connected to the first planet carrier deck.
